(19) United States
(12) Patent Application Publication
(10) Pub. No.: US 2025/0187483 A1
(43) Pub. Date: Jun. 12, 2025

(54) CHARGING/DISCHARGING MANAGEMENT SYSTEM

(71) Applicant: TMEIC Corporation, Tokyo (JP)

(72) Inventor: Xiangguo WANG, Chuo-ku, Tokyo (JP)

(73) Assignee: TMEIC Corporation, Tokyo (JP)

(21) Appl. No.: 18/840,932

(22) PCT Filed: Jan. 31, 2023
(86) PCT No.: PCT/JP2023/003088

§ 371 Date: Aug. 23, 2024

(51) Int. Cl. B60L 53/67; B60L 53/10; B60L 53/62; B60L 58/14; H02J 7/06

(52) U.S. Cl. CPC B60L 53/67; B60L 53/11; B60L 53/62; B60L 58/14; H02J 7/06

(57) ABSTRACT

A charging/discharging management system includes a plurality of output parts used to connect with EVs, and a charger connected to a power supply. The charger is configured to charge the EVs connected to the plurality of output parts based on power supplied from the power supply. The charger includes a power supply part configured to convert the power supplied from the power supply into direct current power corresponding to the EVs, a switching part connected with the power supply part and connected with each of the plurality of output parts, and a controller connected with the power supply part and the switching part. The switching part is configured to switch paths between the power supply part and the plurality of output parts. The switching part is configured to supply direct current power output from the power supply part to one of the plurality of output parts.

### FIELD

Embodiments described herein relate generally to a charging/discharging management system.

### BACKGROUND ART

EVs (electric vehicles) are becoming increasingly popular. Also, it is considered that the circulation of used EVs also will increase accordingly.

An EV includes a power storage device that uses a large-capacity lithium ion storage battery or the like. Even when not in use, the voltage of the power storage device decreases due to self-discharge, and unless measures are taken, the power storage device eventually will undesirably reach an over-discharged state. A power storage device that has reached the over-discharged state undesirably degrades easily. Also, a power storage device that has reached the over-discharged state will easily reach an overcharged state in subsequent charging, which may cause failure of the power storage device, etc., and may cause a serious accident. It is therefore necessary to suppress over-discharge of the power storage device by regular charging, even when the EV is not used for a long period of time.

On the other hand, for example, there are cases where EV manufacturers, used car dealers, and the like must store multiple EVs for long periods of time. In such cases, a charging method in which an employee or the like checks the charging status of the EVs one by one and connects the EVs having low voltages to a charger would be extremely labor intensive. Also, a method may be considered in which multiple chargers are prepared, and multiple EVs are connected respectively to the multiple chargers; however, in such a method, the equipment cost is undesirably increased by the installation of the multiple chargers.

It is therefore desirable to be able to more easily suppress over-discharge of multiple EVs while suppressing higher equipment costs, even when the multiple EVs are stored for long periods of time, etc.

### CITATION LIST

### Patent Literature

### [Patent Literature 1]

JP-A 2015-171188 (Kokai)

### SUMMARY OF INVENTION

### Problem to be Solved by the Invention

Embodiments of the invention provide a charging/discharging management system that can more easily suppress over-discharge of multiple EVs while suppressing higher equipment costs.

### Solution to Problem

According to an embodiment of the invention, a charging/discharging management system is provided. The charging/discharging management system includes a plurality of output parts used to connect with EVs, and a charger connected to a power supply. The charger is configured to charge the EVs connected to the plurality of output parts based on power supplied from the power supply. The charger includes a power supply part configured to convert the power supplied from the power supply into direct current power corresponding to the EVs, a switching part connected with the power supply part and connected with each of the plurality of output parts, and a controller connected with the power supply part and the switching part. The switching part is configured to switch paths between the power supply part and the plurality of output parts. The switching part is configured to supply direct current power output from the power supply part to one of the plurality of output parts. The controller is configured to control an operation of the conversion of the power by the power supply part, and control an operation of the switching of the paths by the switching part. The controller is connected with each of the plurality of output parts. The controller is configured to acquire information related to charge amounts of power storage devices mounted in the EVs connected to the plurality of output parts. Based on the acquired information related to the charge amount of the power storage device, the controller is configured to start to charge an EV among the EVs of which the charge amount of the power storage device has reached or dropped below a charging start value by controlling the operation of the switching of the paths by the switching part to connect, to the power supply part, the output part connected to the EV of which the charge amount of the power storage device has reached or dropped below the charging start value and by controlling the operation of the power supply part to output direct current power corresponding to the EV of which the charge amount of the power storage device has reached or dropped below the charging start value. After the charging is started, the controller is configured to end the charging in response to the charge amount of the power storage device of the EV of which the charge amount of the power storage device has reached or dropped below the charging start value reaching or exceeding a charging end value.

### Advantageous Effects of Invention

According to embodiments of the invention, a charging/discharging management system that can more easily suppress over-discharge of multiple EVs while suppressing higher equipment costs is provided.

### BRIEF DESCRIPTION OF DRAWINGS

FIG. 1 is a block diagram schematically illustrating a charging/discharging management system according to an embodiment.

FIG. 2 is a flowchart schematically illustrating an example of an operation of the charging/discharging management system according to the embodiment.

### DESCRIPTION OF EMBODIMENTS

Embodiments will now be described with reference to the drawings.

The drawings are schematic and conceptual; and the relationships between the thicknesses and widths of portions, the proportions of sizes among portions, etc., are not necessarily the same as the actual values. Also, the dimensions and proportions may be illustrated differently among drawings, even for identical portions.

In the specification and drawings, components similar to those described previously or illustrated in an antecedent drawing are marked with the same reference numerals; and a detailed description is omitted as appropriate.

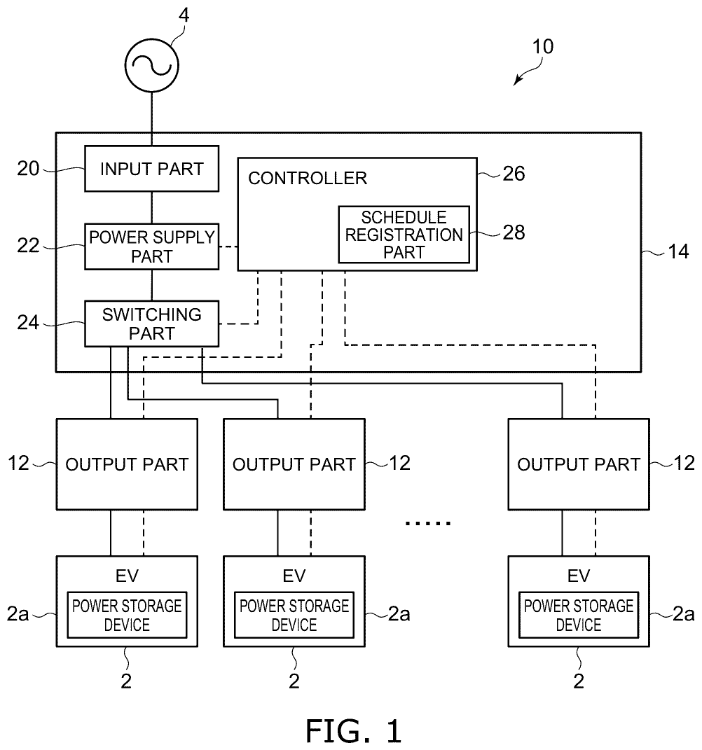

FIG. 1 is a block diagram schematically illustrating a charging/discharging management system according to an embodiment.

As illustrated in FIG. 1, the charging/discharging management system 10 includes multiple output parts 12 and a charger 14. In FIG. 1, power supply lines (lines that carry power supplied to EVs 2) are illustrated by solid lines; and control signal lines (lines that carry control signals) are illustrated by broken lines.

The multiple output parts 12 are used to connect with the EVs 2. The multiple output parts 12 are detachably connected respectively with the EVs 2, and can supply power to the connected EVs 2.

The EV 2 includes a power storage device 2a. The EV 2 is connected with one of the multiple output parts 12, and charges the mounted power storage device 2a by receiving the supply of the power via the connected output part 12. The multiple output parts 12 are, for example, charging plugs that are detachably connected to charging sockets provided in the EVs 2.

The charging/discharging management system 10 make it possible to connect with the multiple EVs 2 by the multiple output parts 12. The charging/discharging management system 10 performs an operation of charging according to the reduction of the charge amount of the power storage device 2a for one or multiple EVs 2 connected to the multiple output parts 12. As a result, the charging/discharging management system 10 suppresses over-discharge of the power storage device 2a of the one or multiple EVs 2 connected to the multiple output parts 12.

The EV 2 may be a BEV (Battery Electric Vehicle) having only a motor as a power source, a PHEV (Plug-in Hybrid Electric Vehicle) having a motor and an engine as power sources, etc. The EV 2 may be any vehicle that includes the power storage device 2a, can travel based on DC power stored in the power storage device 2a, and can charge the power storage device 2a with an external power supply. The power storage device 2a of the EV 2 is, for example, a storage battery, a capacitor, etc. The power storage device 2a may be any device that can store DC power.

The charger 14 includes an input part 20, a power supply part 22, a switching part 24, and a controller 26. The charger 14 is connected to a power supply 4. The charger 14 charges the EVs 2 based on the power supplied from the power supply 4. The power supply 4 is, for example, an AC power system. The power of the power supply 4 is, for example, AC power. However, the power supply 4 is not limited to a power system and may be, for example, a specific generator, renewable energy power supply, etc. The power supply 4 may be any power supply that can appropriately supply the power to the charger 14. The power of the power supply 4 is not limited to AC power and may be DC power, etc.

The input part 20 is connected with the power supply 4, and receives the supply of the power from the power supply 4. The input part 20 includes, for example, a transformer, a circuit breaker, etc. The input part 20 inputs the power supplied from the power supply 4 to the power supply part 22. The configuration of the input part 20 may be any configuration that can receive the supply of the power from the power supply 4 and input the power to the power supply part 22. Also, the input part 20 is provided as necessary, and is omissible. For example, a transformer, a circuit breaker, etc., may be provided separately from the charging/discharging management system 10.

The power supply part 22 is connected to the input part 20 and converts the power supplied from the power supply 4 via the input part 20 into DC power corresponding to the EVs 2. For example, the power supply part 22 converts the AC power supplied from the power supply 4 into DC power corresponding to the EVs 2. The power supply part 22 is, for example, an AC/DC converter. For example, when the power of the power supply 4 is DC power, the power supply part 22 may convert the DC power supplied from the power supply 4 into another DC power corresponding to the EVs 2. The power supply part 22 may be, for example, a DC/DC converter.

The rated voltage of the power supply part 22 is, for example, not less than the total voltage of the power storage device 2a of the EV 2. The total voltage of the power storage device 2a of the EV 2 is, for example, about 400 V. In such a case, the rated voltage of the power supply part 22 is set to be not less than 400 V. The configuration of the power supply part 22 may be any configuration that can convert the power supplied from the power supply 4 into DC power corresponding to the EVs 2. In other words, the configuration of the power supply part 22 may be any configuration that can appropriately charge the power storage devices 2a of the EVs 2 by supplying DC power corresponding to the power storage devices 2a of the EVs 2.

The switching part 24 is connected with the power supply part 22 and connected with each of the multiple output parts 12. The switching part 24 supplies the DC power output from the power supply part 22 to one of the multiple output parts 12 by switching the paths between the power supply part 22 and the multiple output parts 12. In other words, the switching part 24 selectively connects the power supply part 22 with one output part 12 among the multiple output parts 12.

The controller 26 is connected with the power supply part 22 and the switching part 24. The controller 26 controls the operation of the conversion of the power by the power supply part 22, and controls the operation of the switching of the paths by the switching part 24. Also, the controller 26 is connected with the power supply part 22 and the switching part 24, and is connected with each of the multiple output parts 12.

The controller 26 communicates with the one or multiple EVs 2 connected to the multiple output parts 12 via the multiple output parts 12. For example, the controller 26 communicates with ECUs (Electronic Control Units) of the connected EVs 2. As a result, the controller 26 ascertains the connection statuses of the EVs 2 for the multiple output parts 12. In other words, the controller 26 communicates with the connected EVs 2 to be sure which output part 12 is connected with which EV 2.

However, the controller 26 may not always communicate directly with the EVs 2. For example, the multiple output parts 12 may communicate with the connected EVs 2, and the controller 26 may be able to ascertain the connection statuses of the EVs 2 for the multiple output parts 12 by communicating only with the multiple output parts 12.

Also, the controller 26 acquires information related to the charge amounts of the power storage devices 2a by communicating with the connected EVs 2, or the multiple output parts 12 as described above. The controller 26 acquires the information related to the charge amount of the power storage device 2a from the EV 2 connected to one of the multiple output parts 12 by directly communicating with the EV 2, or the controller 26 acquires the information related to the charge amount of the power storage device 2a from the output part 12 connected to the EV 2 by communicating with the multiple output parts 12. For example, the controller 26 regularly acquires the information related to the charge amount of the power storage device 2a of one or multiple EVs 2 connected to the multiple output parts 12.

The information related to the charge amount of the power storage device 2a is, for example, information of the SOC (the State Of Charge) of the power storage device 2a. However, the information related to the charge amount of the power storage device 2a is not limited thereto, and may be any information such that the controller 26 can ascertain the charge amount of the power storage device 2a. The information related to the charge amount of the power storage device 2a may be, for example, information of the voltage value of the power storage device 2a, etc.

The controller 26 controls the operations of the power supply part 22 and the switching part 24 based on the acquired information related to the charge amounts of the power storage devices 2a. Based on the acquired information related to the charge amounts of the power storage devices 2a, the controller 26 determines whether or not the charge amounts of the power storage devices 2a are not more than a charging start value.

When the charge amount of the power storage device 2a of one EV 2 among the one or multiple EVs 2 connected to the multiple output parts 12 reaches or drops below the charging start value, the controller 26 controls the operation of the switching of the paths by the switching part 24 so that the output part 12 connected with the EV 2 of which the charge amount of the power storage device 2a has reached or dropped below the charging start value is connected with the power supply part 22. In other words, when determining that the charge amount of the power storage device 2a has reached or dropped below the charging start value, the controller 26 controls the operation of the switching of the paths by the switching part 24 so that the output part 12 connected with said EV 2 is connected with the power supply part 22.

After controlling the operation of the switching part 24 to connect, to the power supply part 22, the output part 12 connected with the EV 2 of which the charge amount of the power storage device 2a has reached or dropped below the charging start value, the controller 26 controls the operation of the power supply part 22 to output DC power corresponding to the EV 2 of which the charge amount of the power storage device 2a has reached or dropped below the charging start value. For example, the controller 26 communicates with the EV 2 of which the charge amount of the power storage device 2a has reached or dropped below the charging start value or the output part 12 connected with the EV 2, acquires information of the optimal current value of the EV 2, and charges the power storage device 2a mounted in the EV 2 by causing the power supply part 22 to output DC power having the acquired optimal current value. As a result, the controller 26 starts charging the EV 2 of which the charge amount of the power storage device 2a has reached or dropped below the charging start value.

Also, after the charging is started, the controller 26 determines whether or not the charge amount of the power storage device 2a of the EV 2 being charged has reached or exceeded a charging end value based on the information related to the charge amount of the power storage device 2a. After the charging is started, the controller 26 ends the charging of the EV 2 in response to the charge amount of the power storage device 2a reaching or exceeding the charging end value by stopping the output of the power from the power supply part 22 and by disconnecting the connection by the switching part 24 between the power supply part 22 and the output part 12. As a result, over-discharge of the EVs 2 connected to the output parts 12 can be suppressed.

For example, in the case of a ternary lithium ion storage battery, the over-discharge region of the power storage device 2a is the region of less than 2.7 V. For example, when the information related to the charge amount of the power storage device 2a is information of the voltage value of the power storage device 2a, the charging start value is set to about 3.0 V to have a certain margin above the over-discharge voltage. For example, when the information related to the charge amount of the power storage device 2a is information of the SOC of the power storage device 2a, the charging start value is set to about several % (e.g., 1% to 10%). However, the charging start value is not limited to those described above. The charging start value may be any value such that over-discharge of the power storage device 2a can be appropriately suppressed. The charging start value may be appropriately set according to the information related to the charge amount of the power storage device 2a, etc. On the other hand, for example, it is more favorable to set the charging start value in the range of less than 10% of the charge amount (the SOC) of the power storage device 2a. As a result, for example, the charging of the power storage devices 2a of the EVs 2 can be prevented from being performed frequently, and an undesirable increase of the power consumption of the charging/discharging management system 10 can be suppressed.

The charging end value may be any value greater than the charging start value. However, it is favorable to set the charging end value to be, for example, less than 50% of the charge amount (the SOC) of the power storage device 2a. As a result, compared to when the power storage device 2a is undesirably charged to a high value, degradation of the power storage device 2a can be suppressed, even when the EVs 2 are stored for a long period of time, etc. For example, it is more favorable to set the charging end value to be about 20% (e.g., not less than 15% and not more than 25%) of the charge amount (the SOC) of the power storage device 2a. As a result, degradation of the power storage device 2a can be more appropriately suppressed, and a state-of-charge that is more suited to long-term storage can be set.

The controller 26 includes a schedule registration part 28. When the multiple EVs 2 are connected to the multiple output parts 12, and when charging one EV 2, the controller 26 determines whether or not the charge amounts of the power storage devices 2a of the remaining EVs 2 have reached or dropped below the charging start value based on information related to the charge amounts of the power storage devices 2a of the remaining EVs 2.

When charging one EV 2, and when the charge amount of the power storage device 2a of another EV 2 is determined to have reached or dropped below the charging start value, the controller 26 reserves the charging of the EV 2 of which the charge amount of the power storage device 2a has reached or dropped below the charging start value by registering the information related to the EV 2 of which the charge amount of the power storage device 2a has reached or dropped below the charging start value in the schedule registration part 28. The information related to the EV 2 of which the charge amount of the power storage device 2a has reached or dropped below the charging start value is, for example, the identification information of the connected output part 12, the identification information of the EV 2, etc.

After the charging of the one EV 2 has ended, the controller 26 refers to the schedule registration part 28 to check whether or not there is an EV 2 for which charging was reserved. When there is an EV 2 for which charging was reserved, the controller 26 follows the end of the charging of the one EV 2 by starting to charge the EV 2 for which charging was reserved.

More specifically, the controller 26 stops the operation of the power supply part 22 once in response to the end of the charging of the one EV 2, causes the switching part 24 to switch the paths from the state in which the one EV 2 is connected to the power supply part 22 to the state in which the EV 2 for which charging was reserved is connected to the power supply part 22, and then controls the operation of the power supply part 22 to output DC power corresponding to the EV 2 for which charging was reserved. As a result, the controller 26 starts charging the EV 2 for which charging was reserved.

When charging one EV 2, and when the charge amounts of the power storage devices 2a of other multiple EVs 2 reach or drop below the charging start value, the controller 26 registers the information described above in the schedule registration part 28 in the order of reaching or dropping below the charging start value. As a result, the controller 26 reserves the charging of the multiple EVs 2 in the order of reaching or dropping below the charging start value, and sequentially charges the multiple EVs 2 in the order of reaching or dropping below the charging start value.

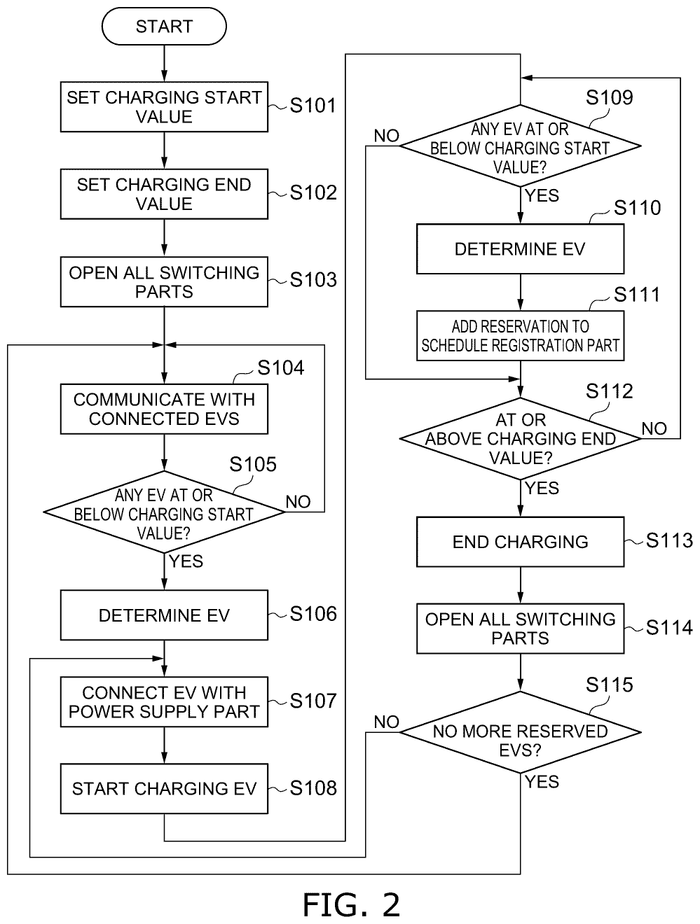

FIG. 2 is a flowchart schematically illustrating an example of an operation of the charging/discharging management system according to the embodiment.

As illustrated in FIG. 2, first, the charging start value is set for the controller 26 of the charger 14 in the charging/discharging management system 10 (step S101 of FIG. 2). Subsequently, the charging end value is set for the controller 26 of the charger 14 (step S102 of FIG. 2).

For example, the setting of the charging start value and the setting of the charging end value are performed by operating an operation part (not illustrated) located in the charger 14. For example, the setting of the charging start value and the setting of the charging end value may be performed based on input from an external device by communication between the controller 26 and the external device. The method of the setting of the charging start value and the setting of the charging end value for the controller 26 may be any method that can appropriately set the charging start value and the charging end value for the controller 26.

The order of the setting of the charging start value and the setting of the charging end value may be reversed, or the setting may be performed substantially simultaneously. Also, the charging start value and the charging end value may be preset. In such a case, the processing of steps S101 and S102 is omissible.

After the setting of the charging start value and the charging end value, the controller 26 controls the operation of the switching of the paths of the switching part 24 to open all of the connections between the power supply part 22 and the multiple output parts 12 (step S103 of FIG. 2). For a standby state or the like in which the charging of the EVs 2 is not being performed, the controller 26 causes the switching part 24 to open the connections between the power supply part 22 and the output parts 12. As a result, the unintended supply of power to the output parts 12 and/or the EVs 2, etc., can be suppressed, and the safety of the charging/discharging management system 10 can be improved.

After causing the switching part 24 to open the connections between the power supply part 22 and the output parts 12, the controller 26 communicates with the EVs 2 connected to the output parts 12 and acquires the information related to the charge amounts of the power storage devices 2a from the EVs 2 connected to the output parts 12 (step S104 of FIG. 2). As described above, the controller 26 may acquire the information related to the charge amounts of the power storage devices 2a by communicating with the output parts 12 without directly communicating with the EVs 2.

Based on the acquired information related to the charge amounts of the power storage devices 2a, the controller 26 determines whether or not there is an EV 2 of which the charge amount of the power storage device 2a has reached or dropped below the charging start value among the EVs 2 connected to the output parts 12 (step S105 of FIG. 2).

When it is determined that there is no EV 2 of which the charge amount of the power storage device 2a has reached or dropped below the charging start value, the controller 26 returns to the processing of step S104 and regularly communicates with the EVs 2 connected to the output parts 12.

On the other hand, when it is determined that there is an EV 2 of which the charge amount of the power storage device 2a has reached or dropped below the charging start value, the controller 26 determines the EV 2 (step S106 of FIG. 2). For example, the controller 26 discriminates the EV 2 of which the charge amount of the power storage device 2a has reached or dropped below the charging start value based on the identification information of the connected output part 12, the identification information of the EV 2, etc.

After determining the EV 2 of which the charge amount of the power storage device 2a has reached or dropped below the charging start value, the controller 26 causes the switching part 24 to switch the paths so that the EV 2 and the power supply part 22 are connected (step S107 of FIG. 2).

After connecting the EV 2 and the power supply part 22, the controller 26 starts charging the EV 2 by controlling the operation of the power supply part 22 to output DC power corresponding to the EV 2 (step S108 of FIG. 2).

After starting the charging of one EV 2, the controller 26 determines whether or not there is an EV 2 of which the charge amount of the power storage device 2a has reached or dropped below the charging start value among the other EVs 2 connected to the output parts 12 (step S109 of FIG. 2).

When it is determined that there is another EV 2 of which the charge amount of the power storage device 2a has reached or dropped below the charging start value, the controller 26 determines the other EV 2 (step S110 of FIG. 2).

When the other EV 2 of which the charge amount of the power storage device 2a has reached or dropped below the charging start value is determined, the controller 26 adds, to the schedule registration part 28, a reservation of the charging of the EV 2 of which the charge amount of the power storage device 2a has reached or dropped below the charging start value by registering, in the schedule registration part 28, the information related to the EV 2 of which the charge amount of the power storage device 2a has reached or dropped below the charging start value (step S111 of FIG. 2).

After reserving the charging of the other EV 2 of which the charge amount of the power storage device 2a has reached or dropped below the charging start value, the controller 26 determines whether or not the charge amount of the power storage device 2a of the EV 2 being charged has reached or exceeded the charging end value based on the information related to the charge amount of the power storage device 2a acquired from the EV 2 being charged (step S112 of FIG. 2).

When the charge amount of the power storage device 2a of the EV 2 being charged is determined to be less than the charging end value, the controller 26 returns to the processing of step

S109. Also, when it is determined in the processing of step S109 that there is no other EV 2 of which the charge amount of the power storage device 2a has reached or dropped below the charging start value, the controller 26 performs the processing of step S112 without performing the processing of steps S110 and S111. In other words, after reserving the charging of the other EV 2 of which the charge amount of the power storage device 2a has reached or dropped below the charging start value or after it is determined that there is no other EV 2 of which the charge amount of the power storage device 2a has reached or dropped below the charging start value, the controller 26 determines whether or not the charge amount of the power storage device 2a of the EV 2 being charged has reached or exceeded the charging end value based on the information related to the charge amount of the power storage device 2a acquired from the EV 2 being charged.

When the charge amount of the power storage device 2a of the EV 2 being charged is determined to be not less than the charging end value, the controller 26 ends the charging of the EV 2 by stopping the output of the power from the power supply part 22 (step S113 of FIG. 2).

After stopping the output of the power from the power supply part 22, the controller 26 controls the operation of the switching of the paths of the switching part 24 to open all of the connections between the power supply part 22 and the multiple output parts 12 (step S114 of FIG. 2).

After causing the switching part 24 to open the connections between the power supply part 22 and the output parts 12, the controller 26 refers to the schedule registration part 28 to determine whether or not there is an EV 2 for which charging was reserved (step S115 of FIG. 2).

When it is determined that there is an EV 2 for which charging was reserved, the controller 26 returns to the processing of step S107, and causes the switching part 24 to switch the paths to connect the power supply part 22 and the EV 2 for which charging was reserved.

When it is determined that there is no EV 2 for which charging was reserved, the controller 26 returns to the processing of step S104, acquires the information related to the charge amounts of the power storage devices 2a from the EVs 2 connected to the output parts 12, and determines whether or not there is an EV 2 of which the charge amount of the power storage device 2a has reached or dropped below the charging start value. Thereafter, the controller 26 repeats similar processing.

Thus, the charging/discharging management system 10 according to the embodiment includes the multiple output parts 12 and the charger 14; the charger 14 includes the power supply part 22, the switching part 24, and the controller 26; and the switching part 24 arbitrarily switches the paths between the power supply part 22 and the multiple output parts 12 to connect the power supply part 22 and the EV 2 of which the charge amount of the power storage device 2a has reached or dropped below the charging start value. As a result, in the charging/discharging management system 10, the multiple EVs 2 can be charged with one charger 14. In the charging/discharging management system 10, compared to a method in which, for example, multiple chargers are prepared and the multiple EVs are respectively connected to the multiple chargers, the system configuration can be simple, and an increase of equipment costs can be suppressed.

Also, in the charging/discharging management system 10, the controller 26 automatically starts charging the EV 2 of which the charge amount of the power storage device 2a has reached or dropped below the charging start value based on the information related to the charge amount of the power storage device 2a. As a result, compared to a charging method in which, for example, an employee or the like checks the charging status of the EVs one by one and connects the EVs having low voltages to a charger, the labor-intensive work by the employee or the like can be suppressed. According to the charging/discharging management system 10, it is unnecessary to check the charging statuses of the EVs 2 one by one and connect the EVs 2 having low voltages one by one to the charger; the charging of the multiple EVs 2 can be automatically performed merely by pre-connecting the multiple EVs 2 to the multiple output parts 12; and over-discharge of the multiple EVs 2 can be easily suppressed.

Accordingly, according to the charging/discharging management system 10 according to the embodiment, over-discharge of the multiple EVs 2 can be more easily suppressed while suppressing an increase of equipment costs, even when the multiple EVs 2 are stored for a long period of time, etc.

Embodiments may include the following configurations.

### Appendix 1

A charging/discharging management system, comprising:
a plurality of output parts used to connect with EVs; and
a charger connected to a power supply, the charger being configured to charge the EVs connected to the plurality of output parts based on power supplied from the power supply,
the charger including
   a power supply part configured to convert the power supplied from the power supply into direct current power corresponding to the EVs,
   a switching part connected with the power supply part and connected with each of the plurality of output parts, the switching part being configured to switch paths between the power supply part and the plurality of output parts, the switching part being configured to supply direct current power output from the power supply part to one of the plurality of output parts, and
   a controller connected with the power supply part and the switching part, the controller being configured to
      control an operation of the conversion of the power by the power supply part, and
      control an operation of the switching of the paths by the switching part,
the controller being connected with each of the plurality of output parts,
the controller acquiring information related to charge amounts of power storage devices mounted in the EVs connected to the plurality of output parts,
based on the acquired information related to the charge amount of the power storage device, the controller starting to charge an EV among the EVs of which the charge amount of the power storage device has reached or dropped below a charging start value by controlling the operation of the switching of the paths by the switching part to connect, to the power supply part, the output part connected to the EV of which the charge amount of the power storage device has reached or dropped below the charging start value and by controlling the operation of the power supply part to output direct current power corresponding to the EV of which the charge amount of the power storage device has reached or dropped below the charging start value,
after the charging is started, the controller ending the charging in response to the charge amount of the power storage device of the EV of which the charge amount of the power storage device has reached or dropped below the charging start value reaching or exceeding a charging end value.

### Appendix 2

The charging/discharging management system according to Appendix 1, wherein
the controller includes a schedule registration part,
when charging one EV among the EVs, and when the charge amount of the power storage device of another EV among the EVs reaches or drops below the charging start value, the controller reserves charging of the EV of which the charge amount of the power storage device has reached or dropped below the charging start value by registering, in the schedule registration part, information related to the EV of which the charge amount of the power storage device has reached or dropped below the charging start value, and
following an end of the charging of the one EV, the controller starts charging the EV for which charging was reserved.

### Appendix 3

The charging/discharging management system according to Appendix 2, wherein
when charging the one EV, and when the charge amounts of the power storage devices of another plurality of EVs among the EVs have reached or dropped below the charging start value, the controller reserves charging of the other plurality of EVs in an order of reaching or dropping below the charging start value by registering the information in the schedule registration part in the order of reaching or dropping below the charging start value, and
the controller sequentially charges the other plurality of EVs in the order of reaching or dropping below the charging start value.

### Appendix 4

The charging/discharging management system according to any one of Appendixes 1 to 3, wherein
the charging start value is set in a range of less than 10% of the charge amount of the power storage device.

### Appendix 5

The charging/discharging management system according to any one of Appendixes 1 to 4, wherein
the charging end value is set to be less than 50% of the charge amount of the power storage device.

### Appendix 6

The charging/discharging management system according to any one of Appendixes 1 to 5, wherein
the controller ascertains connection statuses of the EVs connected to the plurality of output parts by communicating with the EVs connected to the plurality of output parts, or by communicating with the plurality of output parts.

Although several embodiments of the invention are described, these embodiments are presented as examples and are not intended to limit the scope of the invention. These novel embodiments may be carried out in other various forms; and various omissions, substitutions, and modifications can be performed without departing from the spirit of the invention. Such embodiments and their modifications are within the scope and spirit of the invention and are included in the invention described in the claims and their equivalents.

### REFERENCE SIGNS LIST

2 EV, 2a power storage device, 4 power supply, 10 charging/discharging management system, 12 output part, 14 charger, 20 input part, 22 power supply part, 24 switching part, 26 controller, 28 schedule registration part

1. A charging/discharging management system, comprising:
a plurality of output parts used to connect with EVs; and
a charger connected to a power supply, the charger being configured to charge the EVs connected to the plurality of output parts based on power supplied from the power supply,
the charger including
a power supply part configured to convert the power supplied from the power supply into direct current power corresponding to the EVs,
a switching part connected with the power supply part and connected with each of the plurality of output parts, the switching part being configured to switch paths between the power supply part and the plurality of output parts, the switching part being configured to supply direct current power output from the power supply part to one of the plurality of output parts, and
a controller connected with the power supply part and the switching part, the controller being configured to
control an operation of the conversion of the power by the power supply part, and
control an operation of the switching of the paths by the switching part,
the controller being connected with each of the plurality of output parts,
the controller acquiring information related to charge amounts of power storage devices mounted in the EVs connected to the plurality of output parts,
based on the acquired information related to the charge amount of the power storage device, the controller starting to charge an EV among the EVs of which the charge amount of the power storage device has reached or dropped below a charging start value by controlling the operation of the switching of the paths by the switching part to connect, to the power supply part, the output part connected to the EV of which the charge amount of the power storage device has reached or dropped below the charging start value and by controlling the operation of the power supply part to output direct current power corresponding to the EV of which the charge amount of the power storage device has reached or dropped below the charging start value,
after the charging is started, the controller ending the charging in response to the charge amount of the power storage device of the EV of which the charge amount of the power storage device has reached or dropped below the charging start value reaching or exceeding a charging end value.

2. The charging/discharging management system according to claim 1, wherein
the controller includes a schedule registration part,
when charging one EV among the EVs, and when the charge amount of the power storage device of another EV among the EVs reaches or drops below the charging start value, the controller reserves charging of the EV of which the charge amount of the power storage device has reached or dropped below the charging start value by registering, in the schedule registration part, information related to the EV of which the charge amount of the power storage device has reached or dropped below the charging start value, and
following an end of the charging of the one EV, the controller starts charging the EV for which charging was reserved.

3. The charging/discharging management system according to claim 2, wherein
when charging the one EV, and when the charge amounts of the power storage devices of another plurality of EVs among the EVs have reached or dropped below the charging start value, the controller reserves charging of the other plurality of EVs in an order of reaching or dropping below the charging start value by registering the information in the schedule registration part in the order of reaching or dropping below the charging start value, and
the controller sequentially charges the other plurality of EVs in the order of reaching or dropping below the charging start value.

4. The charging/discharging management system according to claim 1, wherein
the charging start value is set in a range of less than 10% of the charge amount of the power storage device.

5. The charging/discharging management system according to claim 1, wherein
the charging end value is set to be less than 50% of the charge amount of the power storage device.

6. The charging/discharging management system according to claim 1, wherein
the controller ascertains connection statuses of the EVs connected to the plurality of output parts by communicating with the EVs connected to the plurality of output parts, or by communicating with the plurality of output parts.
